(19) United States
(12) Patent Application Publication
(10) Pub. No.: US 2004/0257737 A1
(43) Pub. Date: Dec. 23, 2004

(54) Process and system for emergency control of the switching of a power transistor

(76) Inventor: Jean-Pierre Lepage, Aureilhan (FR)

Correspondence Address: DOWELL & DOWELL PC, 2111 Eisenhower Ave., Suite 406, Alexandria, VA, 22314, US

(21) Appl. No.: 10/817,964

(22) Filed: Apr. 6, 2004

(30) Foreign Application Priority Data
Apr. 9, 2003 (FR) 03 04405

(51) Int. Cl. H02H 3/00

(52) U.S. Cl. 361/100

(57) ABSTRACT

This invention relates to a process for emergency control of the switching of a power transistor in the case of dysfunction of this transistor, which comprises:

a step for measuring a voltage between the collector and emitter of the power transistor,

a step for temporal filtering of the measured signal,

a step for detecting the abnormal operational state carried out from the values of the filtered signal, and

a step for controlling the switching of the power transistor towards a safe state, triggered off immediately when an abnormal operational state is detected.

### FIELD OF THE INVENTION

The present invention relates to a process and a system for emergency control of the switching of a power transistor in the event of an abnormal state thereof, and more particularly to a control process comprising:

a step of measuring a signal representative of a voltage between the collector and the emitter of the power transistor when the power transistor is conducting,

a step of monitoring the operational state of the power transistor from the measured values of said signal, and

a step of controlling the switching of the power transistor towards a safe state, this step being immediately triggered off when an abnormal operational state is detected during the monitoring step.

### BACKGROUND OF THE INVENTION

Power transistors and in particular IGBTs (Insulated Gate Bipolar Transistors) are used in numerous electronic power circuits such as three-phase inverters intended to supply an electrical rotating machine.

By way of illustration, the three-phase inverters supplying the motors of a train or an underground train use such power transistors. In such applications, it is important to detect an abnormal state or dysfunction of a power transistor as rapidly as possible, so as to avoid any damage of the electronic circuit, or even of the electrical rotating machine supplied by this circuit.

Such an abnormal state of a power transistor is for example detected by monitoring the voltage V_{CE} between the collector and the emitter of this power transistor when the latter is conducting. In effect, when the power transistor is conducting, it is known that the voltage V_{CE} must be less than a threshold given by the constructor of this transistor, for example 5V.

In order to monitor this voltage, the known process consists in measuring the voltage V_{CE} and in comparing it with a fixed threshold S. If the voltage V_{CE} measured during the conducting state of the power transistor is higher than the threshold S, this means that an abnormal state is present. In the case of presence of an abnormal state, the normal control of the power transistor is interrupted and it receives an instruction for emergency switching towards a safe state, i.e. for example towards the blocked or open state. In the contrary case, i.e. if the voltage V_{CE} measured remains less than 5V, in that case the state of the power transistor is normal and no emergency switching is necessary.

This process is carried out by an electronic circuit for determining an abnormal state of the power transistor. This circuit is connected to the power transistor and placed in the vicinity thereof in order to be able to react rapidly, i.e. in a time of the order of a microsecond.

However, the environment in the vicinity of the power transistor is extremely noisy from an electromagnetic standpoint and the quality of the voltage V_{CE} measured is affected thereby. In particular, the voltage V_{CE} presents numerous transitory voltage peaks or disturbances of which the maximum amplitude is much higher than the threshold of 5V. In order not to interrupt the functioning of the power transistor at every transitory voltage peak, the present solution consists in adjusting the value of the threshold S to a value clearly higher than 5V, for example 100V.

This solution is based on the fact that the majority of the transitory disturbances or peaks have a limited amplitude. However, this solution presents the drawback that a truly abnormal state is detected very late, i.e. when the voltage V_{CE} already exceeds 100V. It is then often too late to react and prevent irreversible damage being caused to the power transistor. This solution thus proves inefficient in practice.

It is an object of the invention to overcome this drawback by proposing a more efficient process for emergency control of a power transistor in the event of dysfunction thereof.

### SUMMARY OF THE INVENTION

The invention therefore has for its object a process for emergency control of a power transistor as described hereinabove, characterized in that the monitoring step comprises:

a sub-step for temporal filtering of the signal measured so as to eliminate all the transitory disturbances of said signal whose durations are less than a predetermined duration, and

a sub-step for detection of the abnormal operational state carried out from the values of the signal in which the transitory disturbances have been filtered.

Contrary to the known processes, the above process comprises a step for temporal filtering of the signal representative of the voltage V_{CE} so as to eliminate from this signal the disturbances whose durations are less than a predetermined time interval Δₜ.

The detection of and decision as to the presence of an abnormal state is made only on the basis of the signal thus filtered, with the result that this decision is not affected by the presence of transitory disturbances, i.e. disturbances of which the duration is less than the interval Δₜ. In this way, this process is more efficient than the known processes since the interruption of the normal functioning of the power transistor is effected only when this proves really necessary.

According to other characteristics of the process in accordance with the invention:

the sub-step of temporal filtering consists in detecting the beginning of a transitory disturbance and in carrying out the sub-step of detection only after the determined time interval has elapsed, the time interval being counted from the detection of the beginning of the disturbance,

the beginning of the disturbance is detected by comparing the instantaneous value of the measured signal with a first threshold,

the sub-step of detection of the abnormal state comprises an operation of comparison of the instantaneous value of said measured signal with a second threshold, and the control step is triggered off solely if the result of this comparison with the second threshold indicates that the disturbance is still present after the predetermined time interval has elapsed,

the step of monitoring comprises a sub-step of prevention of a destructive operational state consisting in immediately triggering off the control step as soon as the instantaneous value of said measured signal exceeds a third threshold beyond which the power transistor risks being damaged.

this process comprises a step of initialization of the predetermined time interval at a constant value before carrying out the sub-step of filtering.

it comprises a step of initialization of the or each threshold at a constant value, before the sub-step of filtering.

the sub-step of filtering comprises an operation of digital filtering of said measured signal, the sub-step of detection comprises an operation of comparison of the filtered signal with a predetermined threshold, the result of this comparison being representative of the presence or absence of an abnormal operational state, and the control step is triggered off only if the result of the comparison indicates that an abnormal operational state is present.

The invention also has for an object a system for emergency control of the switching of a power transistor, in the event of dysfunction of this transistor, the system being adapted to:

measure a signal representative of a voltage between the collector and the emitter of the power transistor when the power transistor is conducting,

monitor the operational state of the power transistor from the measured values of said signal, and

control the switching of the power transistor towards a safe state immediately in response to the detection of an abnormal operational state,

characterized in that the system is also capable of:

filtering the measured signal in temporal manner so as to eliminate all the transitory disturbances of said signal whose durations are less than a predetermined duration, and

detecting the abnormal operational state from the values of the signal in which the transitory disturbances have been filtered.

### BRIEF DESCRIPTION OF THE DRAWINGS

The invention will be more readily understood on reading the following description given solely by way of example and made with reference to the accompanying drawings, in which:

FIG. 1 schematically illustrates the general structure of an electronic switching device.

FIG. 2 is an illustration of a system for controlling a power transistor according to the invention.

FIG. 3 is a flowchart of a process for controlling a power transistor according to the invention.

FIGS. 4A and 4B are each a schematic illustration of a disturbance affecting a power transistor.

FIG. 5 is an illustration of a second form of embodiment of a control system according to the invention.

FIG. 6 is a flowchart of a control process according to the invention carried out by the system of FIG. 5, and

FIGS. 7A, 7B and 7C are illustrations of disturbances affecting the power transistor.

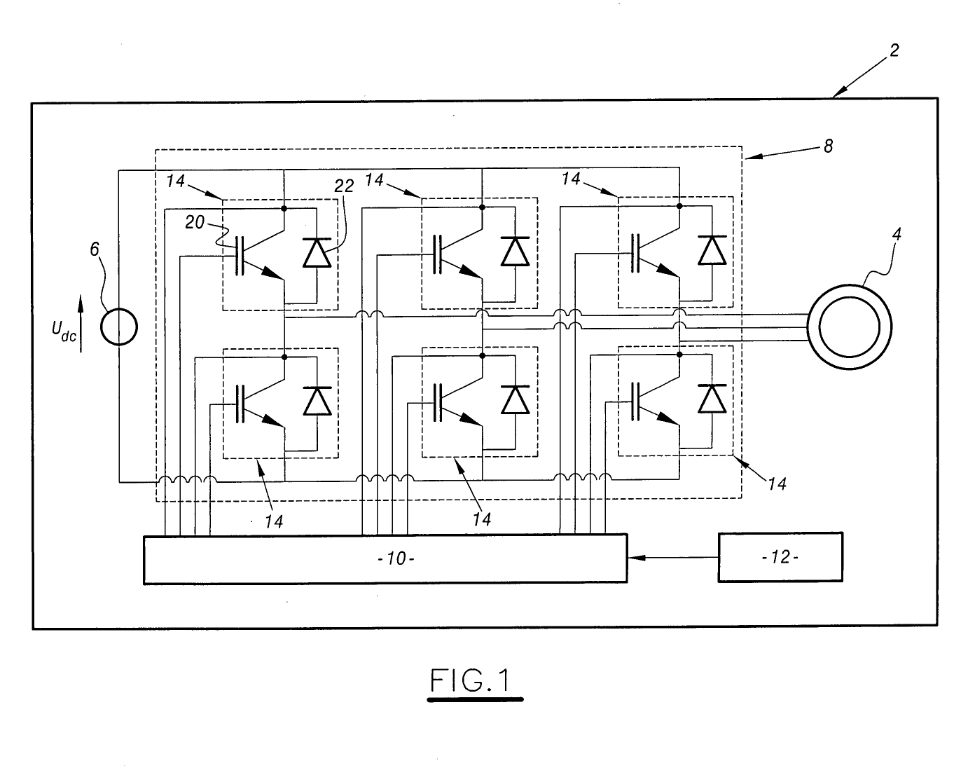

### DESCRIPTION OF PREFERRED EMBODIMENTS

Referring now to the drawings, FIG. I shows the general structure of an example of a three-phase electronic switching device 2. This device 2 comprises an electrical rotating machine 4 connected to a source 6 of D.C. voltage via a three-phase inverter 8. The system 2 also comprises an ignition device IO intended to control the inverter 8 as a function of controls transmitted by a computer 12.

The electrical rotating machine 4 is for example an electric motor is intended to rotate the driving wheels of a vehicle such as those of a train.

The three-phase inverter 8 is conventional and formed by six D.C. voltage switching units.

Each switching unit is here made with the aid of a power switch 14. Each switch 14 is capable of switching currents going up to 1000 amperes. In order to achieve such performances, this switch 14 is made from a plurality of elementary power transistors connected in parallel and from elementary diodes connected in anti-parallel position between the collector and the emitter of these elementary transistors. These elementary transistors are for example IGBTs (Insulated Gate Bipolar Transistors) each capable of switching a current from 100 to 150 amperes, and of withstanding a voltage V_{CE} between the collector and the emitter in the blocked state ranging from 250 to 6500 volts. In the conducting state, the voltage V_{CE} is conventionally less than 5 volts.

All the elementary transistors of the same switch are controlled in identical manner by the computer 12, with the result that they behave functionally like one large transistor connected in anti-parallel position to the terminals of a diode. The equivalent electrical diagram of the switch 14 is therefore formed by a transistor 20 at whose terminals there is connected a diode 22 in anti-parallel position. The following description will be made solely by using this equivalent electrical diagram, with the result that the term transistor designates solely transistor 20.

The ignition device 10 is adapted to control switching of each transistor 20 as a function of the instructions transmitted by the computer 12. In particular, it is adapted to control the transistors 20 so as to deliver to the machine 4 a three-phase voltage corresponding either to the maintenance of the speed of the train, or to an acceleration or a deceleration of the train.

To that end, the ignition device 10 is connected to the gate of each of the transistors 20.

Moreover, in this form of embodiment, the ignition device 10 is connected to each of the transistors 20 so as to measure a signal representative of the voltage V_{CE} present between the collector and the emitter of each of the transistors 20.

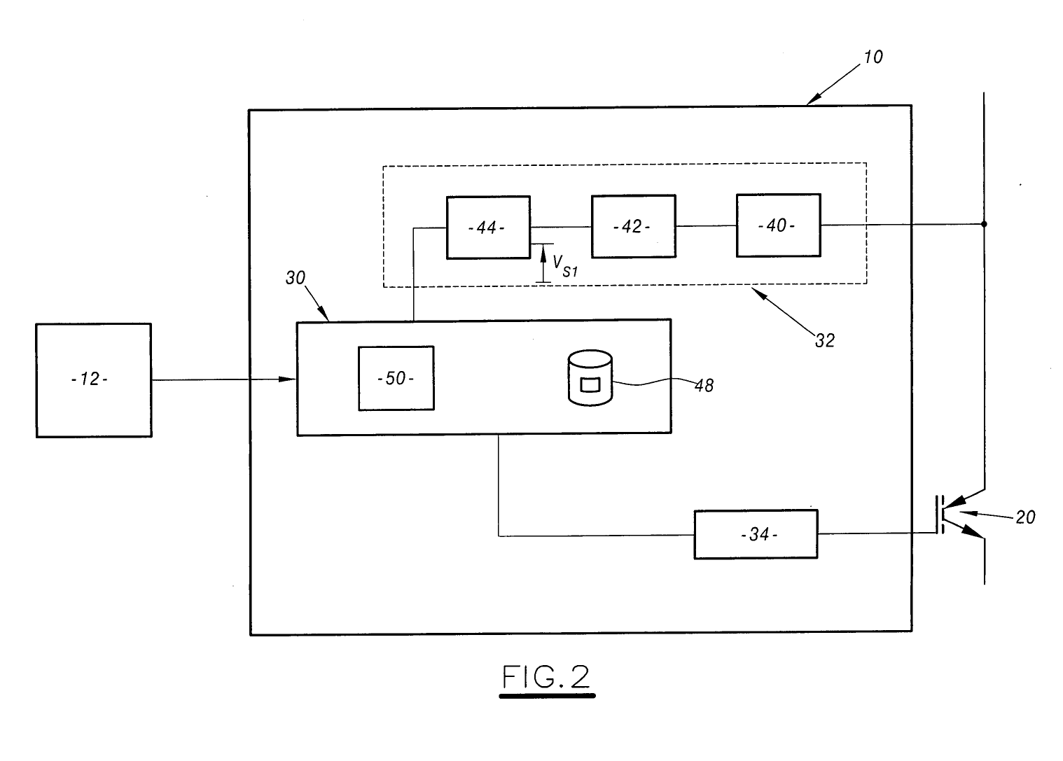

The arrangement of the ignition device 10 for controlling the switching of the transistors 20 as a function of the instructions of the computer 12 is conventional and will not be described here in detail. In the following description, only the arrangement of this ignition device 10, corresponding to a system for emergency control of the switching of a power transistor in the event of dysfunction of the latter, is described hereinbelow with reference in particular to FIG. 2.

FIG. 2 shows the ignition device 10 in which a system for emergency control of the transistors 20 is implanted. The emergency control system being the same for each transistor 20, only the emergency control system of one transistor 20 is described here in detail.

The emergency control system is adapted to detect an abnormal state of dysfunction of the transistor 20 and to control the transistor 20 in response to the detection of this abnormal state in order to cause it pass into a safe state, i.e. here into the blocked state.

The abnormal state is here defined as being a voltage V_{CE} higher than a threshold S₁ for a time interval Δₜ. In the form of embodiment described here, the value of the threshold S₁ is constant and equal to 10V and the value of the interval Δₜ, is constant and equal to 10 μs.

Other acceptable values for this threshold S₁ are included between 5 and 45 V and other acceptable values for the interval Δₜ are included between 3 μs and 20 μs

The ignition device 10 comprises a logic processing unit 30 connected to a threshold detection circuit 32 and to a unit 34 for piloting the voltage V_{GE} of the transistor 20.

The circuit 32 is intended to detect the crossing of the threshold S₁ by the voltage V_{CE}. To that end, it comprises, connected in series, a step-down transformer 40, a voltage divider bridge 42 and an analog comparator 44. The step-down transformer 40 is adapted to convert the voltage V_{CE} collected at the terminals of the transistor 20 into a voltage which is proportional but included between 0 and 25 V.

The voltage divider bridge converts the voltage delivered by the step-down transformer 40 into a voltage which is proportional but included between 0 and 5 V.

Finally, the comparator 44 is adapted to compare the voltage delivered by the bridge 42 with a reference voltage V_{S1}, corresponding to the value of the threshold S₁, and to deliver the result of this comparison in the form of an all-or-nothing-signal to logic processing unit 30.

The piloting unit 34 is intended to switch the state of the transistor 20 under the control of the logic processing unit 30. To that end, the piloting unit 34 is connected to the gate of the transistor 20 in order to pilot the voltage V_{GE} of this transistor 20. The unit 34 is adapted to deliver a first voltage adapted to cause the transistor to pass from the conducting state to the blocked state and a second voltage adapted to cause the transistor 20 to pass from the blocked state to the conducting state.

The first and second voltages are for example respectively equal to −10 V and to +15V.

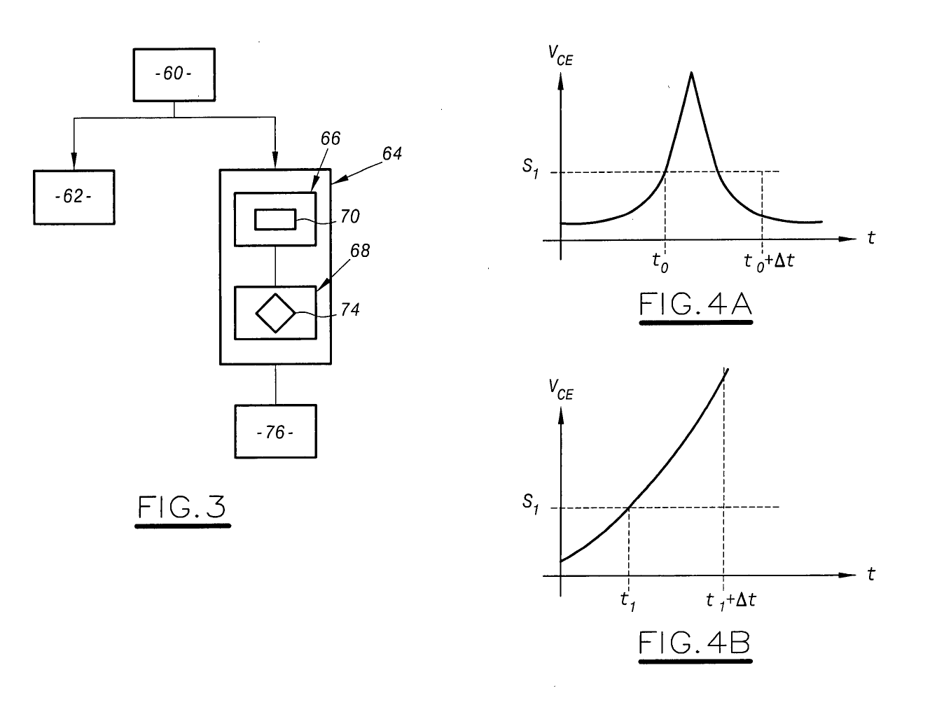

The logic processing unit 30 is intended to control the piloting unit 34 as a function of the result of the comparison delivered by the comparator 44. The unit 30 is here a programmable digital data processing unit. Advantageously and so as to withstand the electromagnetic disturbances due to the proximity of the transistors 20, this unit 30 is made from a CPLD (Complex Programmable Logic Device) component programmed in a VHDL language (Very High speed integrated circuit Hardware Description Language). Here, this logic processing unit is adapted and programmed to carry out the process of FIG. 3. In particular, the unit 30 comprises a memory 48 and a timer 50. The memory 48 contains the value of the interval Δₜ defined hereinabove. This value is here constant as long as the emergency control system is active.

Functioning of the ignition device 10 will now be described with regard to the process of FIG. 3.

During, for example, the programming of the CPLD component forming the logic processing unit 30, a step 60 of initialization of the value of the time interval Δₜ is carried out. Here, this step consists in recording the value of 10 μs in the memory 48. The voltage V_{S1}, is adjusted during this same step.

Once the ignition device 10 is activated, the latter then proceeds permanently with a step 62 for measuring the voltage V_{CE}. This step 62 is carried out by the step-down transformer 40 and the voltage divider bridge 42 which delivers to the input of the comparator 44 a signal representative of the voltage V_{CE}.

Simultaneously and in parallel to step 62, the ignition device 10 permanently carries out a step 64 for monitoring the operational state of the transistor 20 when the latter is conducting.

This step 64 principally comprises a sub-step 66 for temporal filtering and a sub-step 68 for detecting the presence of an abnormal state.

During the sub-step 66, the comparator 44 carries out an operation of comparison of the value of the signal delivered by the bridge 42 with the threshold S₁ represented by the voltage V_{S1}. The comparator 44 immediately delivers the result of this comparison to the logic processing unit 30 in the form of a binary or TTL (Transistor-Transistor Logic) signal such as, for example, 0 V to indicate that the threshold S₁ has not been crossed and 5 V to indicate that the threshold S₁ has been crossed.

During the sub-step 66, the logic process unit 30 permanently monitors the value of the signal delivered by the comparator 44, so as to detect the beginning of a disturbance immediately. The beginning of a disturbance is here detected when the value of the signal delivered by the comparator 44 passes to value 5 V.

As soon as the beginning of a disturbance has been detected, the unit 30 triggers off the timer 50 during operation 70, and permanently verifies its value. If the value of the timer 50 is equal to the pre-recorded interval Δₜ, the unit 30 proceeds with the sub-step 68 of detection of an abnormal operational state of the transistor 20. This sub-step 68 consists here in carrying out an operation 74 of comparison of the instantaneous value of the voltage V_{CE} with a threshold S₂. So as to simplify assembly of the ignition device 10, this threshold S₂ is here chosen to be equal to the threshold S₁. Consequently, the operation 70 here consists only in determining the value presently delivered by the comparator 44.

If the value delivered by the comparator 44 indicates that the voltage V_{CE} is less than the threshold S₁, then no particular control of the transistor 20 is triggered off. In the contrary case, i.e. if the value delivered by the comparator 44 indicates that the voltage V_{CE} is always higher than the threshold S₁, then the unit 30 immediately proceeds with a step 76 for emergency control of the switching of the transistor 20.

During this step 76, the unit 30 controls the piloting unit 34 in order to apply a voltage equal to −10 V on the gate of the transistor 20. In response to this voltage of −10 V, the transistor 20 passes from the conducting state to the blocked state.

In the form of embodiment described here, the step 66 is carried out only from the moment when the ignition device 10 has received an instruction from the computer 12 to cause the transistor 20 to pass from the blocked state to the conducting state, and up to the instant when the ignition device 10 receives a fresh instruction from the computer 12 to cause the transistor 20 to pass from the conducting state to the blocked state.

FIGS. 4A and 4B show two examples of disturbance of the voltage V_{CE}. The graph of FIG. 4A represents a transitory disturbance, while FIG. 4B represents an abnormal state of the voltage V_{CE}.

In FIG. 4A, at an instant t₀, the voltage becomes higher than the threshold S₁ for an time interval less than Δₜ. In that case, the ignition device 10 waits for an time interval Δₜ after the voltage V_{CE} has crossed the threshold S₁ for the first time, before carrying out the sub-step 68 of detection.

During execution of the sub-step 68, no abnormal state is detected since the voltage V_{CE} has meanwhile become lower than the threshold S₁ again. Consequently, the transitory disturbances of the voltage V_{CE} of which the duration is less than Δₜ do not provoke untimely triggering off of the step 76 for emergency control of the transistor 20. In this way, the process described filters the disturbances of which the duration is less than Δₜ without necessitating the implementation of complex filtering algorithms.

In FIG. 4B, the voltage V_{CE} becomes higher than the threshold S₁ at instant t₁. However, in the case shown in FIG. 4B, the voltage, after having crossed the threshold S₁, continues to increase. Consequently, at instant t₁+Δₜ, the voltage V_{CE} is always higher than the threshold S₁. In such a situation, the process of FIG. 3 leads to triggering off the step 76 for emergency control of the transistor 20 since, at instant t₁+Δₜ, the unit 30 detects an abnormal state.

It is important to note that the value of the interval Δₜ must be chosen so as to leave sufficient time for the piloting unit 34 to switch the transistor 20 towards the blocked state before the latter is definitively deteriorated due to this abnormal state. For the majority of the power transistors used, the time interval Δₜ is substantially included between 3 μs and 20 μs.

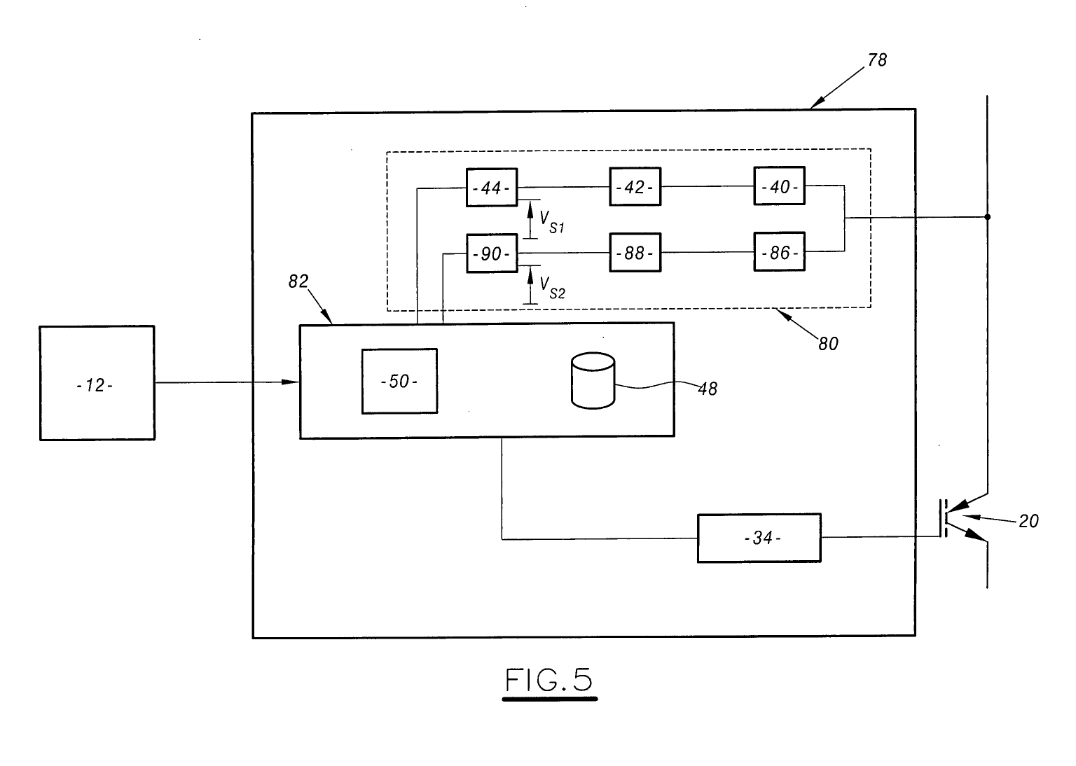

FIG. 5 shows a second form of embodiment 78 of the ignition device 10. The ignition device 78 is identical to that described with regard to FIG. 2 except for the fact that the threshold detection circuit 32 and the logic processing unit 30 are respectively replaced by a threshold detection circuit 80 and a logic processing unit 82.

The other elements already described with regard to FIG. 2 bear the same references in FIG. 5.

The threshold detection circuit 80 is capable of comparing the voltage V_{CE} with the threshold S₁ and also with a threshold S₂. The circuit for comparing the voltage V_{CE} with the threshold S₁ is for example identical to that described with regard to FIG. 2 and here bears the same numerical references. The circuit for comparing the voltage V_{CE} with the threshold S₂ is similar to the circuit comparing the voltage V_{CE} with the threshold S₁. It is thus formed by a step-down transformer 86, a voltage divider bridge 88 and a comparator 90 connected in series. Elements 86, 88 and 90 being conventional, they will not be described here in detail. The result of the comparison of the voltage V_{CE} with the threshold S₂, represented by a voltage V_{S2}, is delivered to the logic processing unit 82 in the form of a TTL signal.

The threshold S₂ corresponds to a value of the voltage V_{CE} beyond which the power transistor 20 risks being damaged.

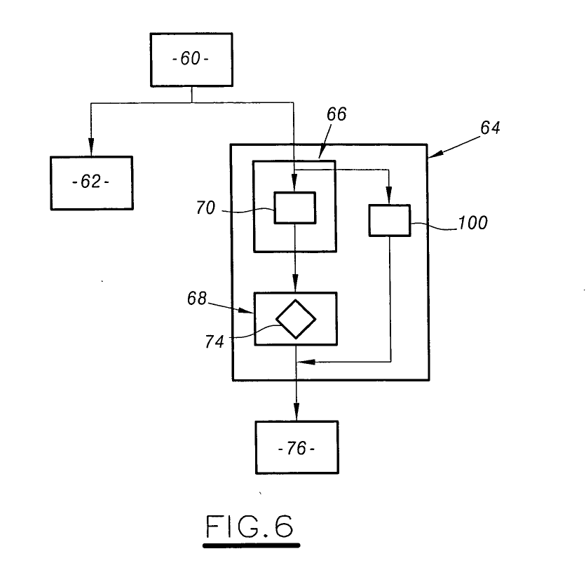

The logic processing unit 82 is for example materially identical to the logic processing unit 30 but adapted and programmed to carry out the process of FIG. 6.

The process of FIG. 6 is identical to that described with regard to FIG. 3, except for the fact that it comprises an additional sub-step 100 for preventing a destructive operational state.

This sub-step 100 is triggered off by the unit 82 at the same time as the operation 70, i.e. as soon as the value of the voltage V_{CE} rises above the threshold S₁. During this sub-step 100, the detection circuit 80 permanently compares the value of the voltage V_{CE} with the threshold S₂ and the logic processing unit monitors the result of this comparison. If the result delivered to the logic processing unit 82 indicates that the voltage V_{CE} has crossed the threshold S₂, during the sub-step 100, then the unit 82 immediately proceeds with the step 76 for emergency control of the power transistor. This sub-step 100 is solely carried out during the whole duration of the time interval Δₜ. Once the time interval Δₜ has elapsed, the sub-step 100 is de-activated.

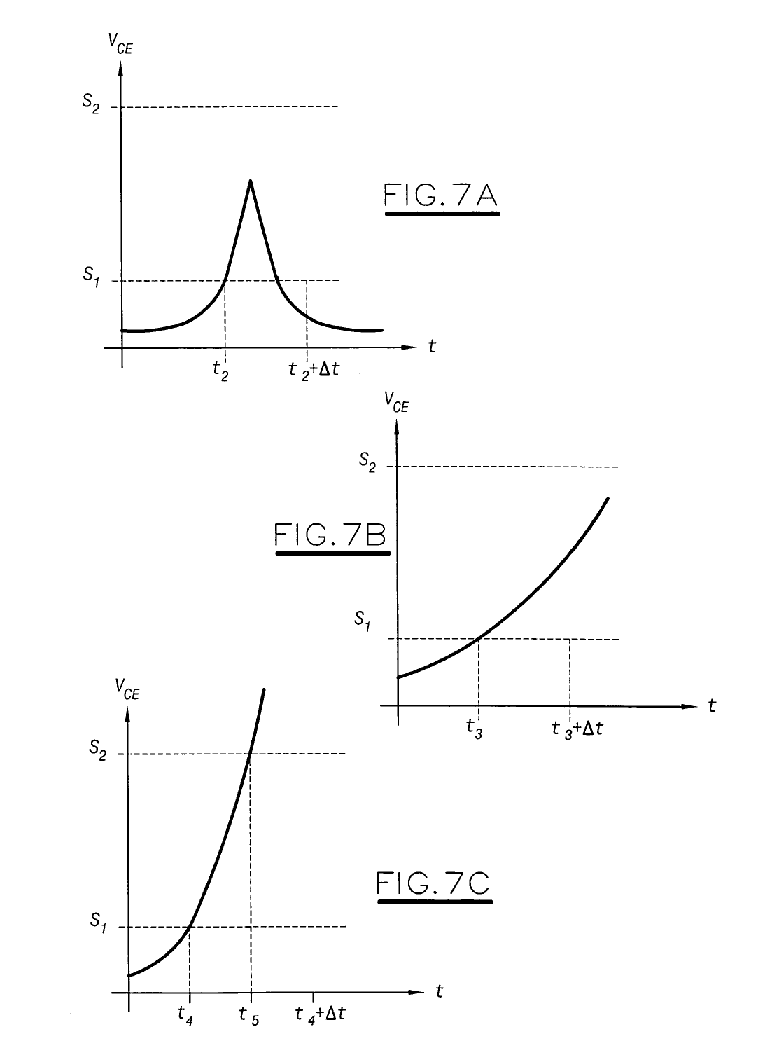

Functioning of the emergency control system of FIG. 5 will now be illustrated in the particular cases of the disturbances presented in FIGS. 7A to 7C.

FIGS. 7A to 7C represent the evolution of the voltage V_{CE} as a function of time. In FIG. 7A, the voltage V_{CE} becomes higher than the threshold S₁ at instant t₂, then passes through a maximum of which the amplitude is less than the threshold S₂ and then redescends before instant t₂+Δₜ below the threshold is S₁. In this case, the ignition device 78 behaves exactly like the ignition device 10 and the step for emergency control of the transistor 20 is not carried out.

In FIG. 7B, the voltage V_{CE} rises above the threshold S₁ at the instant t₃ and continues to increase progressively up to instant t₃+Δₜ. At that instant t₃+Δₜ, the value of the voltage V_{CE} is lower than threshold S₂. In this case, the functioning of the ignition device 78 is identical to that of the ignition device 10 described with regard to FIG. 4B.

In FIG. 7C, the voltage V_{CE} crosses the threshold S₁ at instant t₄ and then increases very rapidly, crossing the threshold S₂ at an instant t₅ strictly less than instant t₄+Δₜ. In this situation, at instant t₅, the ignition device 78, which proceeds with the sub-step 100, detects that the threshold S₂ has been crossed by the voltage V_{CE} and, consequently, immediately carries out the step 76 for emergency control of the transistor 20 without waiting for the time interval Δₜ, to elapse.

The second form of embodiment presents the same advantages as that described with regard to FIGS. 2 to 3, i.e. it does not trigger off the step of emergency control of the transistor 20 in untimely manner.

Moreover, this second form of embodiment presents the advantage of guaranteeing that, at the instant when the emergency control step is carried out, the voltage V_{CE} is lower than or equal to the threshold S₂, i.e. that the voltage is still sufficiently low in order not to have, for example, damaged the transistor 20. In this way, the choice of the value of the time interval Δₜ is facilitated thereby.

In a variant embodiment, the logic processing unit is adapted to measure the duration during which the voltage V_{CE} is higher than the threshold S₁. In this variant, the logic processing unit is capable of using the duration measured in order automatically to adjust the threshold S₁. For example, the logic processing unit is programmed in order automatically to decrease the value of the threshold S₁ when the duration of the majority of the transitory disturbances is very clearly less than the value of the interval Δₜ. In this way, in this variant, the value of the threshold S₁ is optimized.

Similarly to the preceding variant, the threshold S₂ and possibly the time interval Δₜ are also automatically adjusted by the logic processing unit.

The process has been described here in the particular case of the control of a power switch made from a plurality of elementary transistors. However, in a variant, this process is also applicable to the control and monitoring of one elementary transistor only, for example of the IGBT, MOFSET or FET type.

Finally, in a variant embodiment which is more complicated to carry out, the threshold detection circuit is replaced by a analog-digital converter adapted to deliver to the logic processing unit the value of the voltage V_{CE}. In this variant, the logic processing unit is programmed to implement conventional digital filtering algorithms making it possible to eliminate the transitory disturbances by which the voltage V_{CE} is affected before detecting the presence of an abnormal state from the signal thus filtered.

What is claimed is:

1. Process for emergency control of the switching of a circuit, forming power transistor, in the event of an abnormal state of this circuit, comprising:
a step of measuring a signal representative of a voltage between the collector and the emitter of the circuit when the circuit is conducting,
a step of monitoring the operational state of the circuit from the measured values of said signal, and
a step of controlling the switching of the circuit towards a safe state, this step being immediately triggered off when an abnormal operational state is detected during the monitoring step, wherein the monitoring step comprises:
a sub-step for temporal filtering of the signal measured so as to eliminate all the transitory disturbances of said signal whose durations are less than a predetermined duration,
a sub-step for detection of the abnormal operational state carried out from the values of the signal in which the transitory disturbances have been filtered, and
a sub-step for prevention of a destructive operational state consisting in immediately triggering off the control step as soon as the instantaneous value of said measured signal crosses a first threshold beyond which the circuit forming power transistor risks being damaged.

2. The process of claim 1, wherein the sub-step of temporal filtering consists in detecting the beginning of a transitory disturbance and in carrying out the sub-step for detection only after the predetermined time interval has elapsed, the time interval being counted from the detection of the beginning of the disturbance.

3. The process of claim 2, wherein the beginning of the disturbance is detected by comparing the instantaneous value of the measured signal with a second threshold.

4. The process of claim 2, wherein the sub-step for detection of the abnormal state comprises an operation of comparison of the instantaneous value of said measured signal with a third threshold, and
the control step is triggered off solely if the result of this comparison with the third threshold indicates that the disturbance is still present after the predetermined time interval has elapsed.

5. The process of claim 1, wherein it comprises a step for initialization of the predetermined time interval at a constant value before carrying out the sub-step for filtering.

6. The process of claim 1, wherein it comprises a step for initialization of the or each threshold at a constant value, before the sub-step for filtering.

7. The process of claim 1, wherein
the sub-step of filtering comprises an operation of digital filtering of said measured signal,
the sub-step of detection comprises an operation of comparison of the filtered signal with a predetermined threshold, the result of this comparison being representative of the presence or absence of an abnormal operational state, and
the control step is triggered off only if the result of the comparison indicates that an abnormal operational state is present.

8. System for emergency control of the switching of a circuit forming power transistor, in the event of dysfunction of this circuit, the system comprising means for:
measuring a signal representative of a voltage between the collector and the emitter of the circuit when the circuit is conducting,
monitoring the operational state of the circuit from the measured values of said signal, and
controlling the switching of the circuit towards a safe state immediately in response to the detection of an abnormal operational state,
wherein the system also comprises means for:
filtering the measured signal in temporal manner so as to eliminate all the transitory disturbances of said signal whose durations are less than a predetermined duration,
detecting the abnormal operational state from the values of the signal in which the transitory disturbances have been filtered, and
preventing a destructive operational state by immediately triggering off switching of the circuit towards a safe state as soon as the instantaneous value of a signal measured by the measuring means crosses a first threshold beyond which the circuit forming power transistor risks being damaged.
